(19) United States
(12) Patent Application Publication
(10) Pub. No.: US 2025/0080311 A1
(43) Pub. Date: Mar. 6, 2025

(54) SECONDARY CELL SCELL ACTIVATION METHOD AND DEVICE

(71) Applicant: VIVO MOBILE COMMUNICATION CO., LTD., Dongguan (CN)

(72) Inventors: Wenkuan QU, Dongguan (CN); Xiaodong YANG, Dongguan (CN); Qian YANG, Dongguan (CN); Yanliang SUN, Dongguan (CN); Minhua ZHENG, Dongguan (CN)

(73) Assignee: VIVO MOBILE COMMUNICATION CO., LTD., Dongguan (CN)

(21) Appl. No.: 18/949,943

(22) Filed: Nov. 15, 2024

Related U.S. Application Data
(63) Continuation of application No. PCT/CN2023/093759, filed on May 12, 2023.

(30) Foreign Application Priority Data
May 16, 2022 (CN) 202210531288.X

(51) Int. Cl. H04L 5/00; H04B 17/318; H04L 1/1812; H04W 76/28

(52) U.S. Cl. CPC H04L 5/0098; H04B 17/328; H04L 1/1812; H04L 5/0051; H04W 76/28

(57) ABSTRACT

This application discloses a secondary cell (SCell) activation method and device. The method includes: receiving, by a terminal, a SCell activation command, and executing a SCell activation operation based on the SCell activation command. The terminal meets at least one of the following conditions when executing the SCell activation operation: a first receive beam scanning factor is less than a target receive beam scanning factor; a first quantity of receive beam scanning times is less than a target quantity of scanning times when L1 reference signal received power (L1-RSRP) measurement is performed; or there is no condition restriction on a discontinuous reception (DRX) state during L1-RSRP measurement.

### CROSS-REFERENCE TO RELATED APPLICATIONS

This application is a continuation of International Application No. PCT/CN 2023/093759, filed on May 12, 2023, which claims priority to Chinese Patent Application No. 202210531288.X, field on May 16, 2022. The entire contents of each of the above-referenced applications are expressly incorporated herein by reference.

### TECHNICAL FIELD

This application pertains to the field of communication technologies, and specifically relates to a secondary cell SCell activation method and device.

### BACKGROUND

A Secondary Cell (SCell) activation delay is a delay between starting of receiving a SCell activation command by a terminal and ending of transmitting a valid Channel State Information (CSI) report by the terminal. In some embodiments, the SCell activation delay may include: (1) processing duration of the SCell activation command; (2) duration of cell detection; (3) duration of Automatic Gain Control (AGC) adjustment; (4) duration of L1 reference signal received power (Layer 1 Reference Signal Received Power (L1-RSRP)) measurement and reporting; (5) activation duration of a Transmission Configuration Indicator (TCI) state; (6) duration of fine synchronization; and (7) duration of CSI measurement and reporting. In a case that a SCell is a known cell, an activation delay may include the foregoing (1) and (5) to (7); or in a case that a SCell is an unknown cell, an activation delay may include the foregoing (1) to (7).

Currently, the SCell activation delay is relatively long, and consequently has a relatively large impact on terminal performance.

### SUMMARY

Embodiments of this application provide a secondary cell SCell activation method and device, so as to improve terminal performance.

According to a first aspect, a secondary cell SCell activation method is provided, and the method includes:
receiving, by a terminal, a SCell activation command, and executing a SCell activation operation based on the SCell activation command, where the terminal meets at least one of the following conditions when executing the SCell activation operation:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

According to a second aspect, a secondary cell SCell activation method is provided, and the method includes:
sending, by a network side device, a SCell activation command, where the SCell activation command is used to indicate a terminal to execute a SCell activation operation, where the terminal meets at least one of the following conditions when executing the SCell activation operation:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

According to a third aspect, a secondary cell SCell activation apparatus is provided, and the apparatus includes:
a receiving module, configured to receive a SCell activation command; and
an activation module, configured to execute a SCell activation operation based on the SCell activation command, where at least one of the following conditions is met when the SCell activation operation is executed:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

According to a fourth aspect, a secondary cell SCell activation apparatus is provided, and the apparatus includes:
a sending module, configured to send a SCell activation command, where the SCell activation command is used to indicate a terminal to execute a SCell activation operation, where the terminal meets at least one of the following conditions when executing the SCell activation operation:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and

an execution time of an automatic gain control AGC adjustment operation overlaps with that of a fine synchronization operation.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The communication interface is configured to receive a SCell activation command, and the processor is configured to execute a SCell activation operation based on the SCell activation command, where at least one of the following conditions is met when the SCell activation operation is executed:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

According to a seventh aspect, a network side device is provided. The network side device includes a processor and a memory, the memory stores a program or an instruction that can be run on the processor, and the program or the instruction is executed by the processor to implement the steps of the method according to the second aspect.

According to an eighth aspect, a network side device is provided, including a processor and a communication interface. The communication interface is configured to send a SCell activation command, where the SCell activation command is used to indicate a terminal to execute a SCell activation operation, where the terminal meets at least one of the following conditions when executing the SCell activation operation:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

According to a ninth aspect, a communication system is provided, including a terminal and a network side device. The terminal may be configured to perform the steps of the SCell activation method according to the first aspect, and the network side device may be configured to perform the steps of the SCell activation method according to the second aspect.

According to a tenth aspect, a readable storage medium is provided. The readable storage medium stores a program or an instruction, and the program or the instruction is executed by a processor to implement the steps of the method according to the first aspect or the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a storage medium, and the computer program/program product is executed by at least one processor to implement the steps of the SCell activation method according to the first aspect or the steps of the method according to the second aspect.

In the embodiments of this application, a terminal receives a SCell activation command, and executes a SCell activation operation based on the SCell activation command in a case that the terminal meets at least one of the following conditions: (1) A first measurement sampling quantity is less than a target measurement sampling quantity, that is, duration of cell detection, duration of automatic gain control AGC adjustment, and duration of L1 reference signal received power L1-RSRP measurement may be reduced by reducing a measurement sampling quantity. (2) A first receive beam scanning factor is less than a target receive beam scanning factor, that is, duration of cell detection, duration of AGC adjustment, and duration of L1-RSRP measurement may be reduced by reducing a receive beam scanning factor. (3) A first quantity of receive beam scanning times is less than a target quantity of scanning times when L1-RSRP measurement is performed, that is, duration of L1-RSRP measurement may be reduced by reducing a quantity of receive beam scanning times. (4) A first sharing factor is greater than a target sharing factor, where the first sharing factor is used to indicate a priority of the L1-RSRP measurement, so that duration of the L1-RSRP measurement is reduced by increasing the priority of the L1-RSRP measurement. (5) There is no condition restriction on a discontinuous reception DRX state during L1-RSRP measurement, that is, duration of the L1-RSRP measurement can be reduced by ignoring a condition restriction on the DRX state. (6) A transmission configuration indicator TCI state of a physical downlink control channel PDCCH and/or a physical downlink shared channel PDSCH is consistent with a TCI state of a channel state information-reference signal (CSI-RS), that is, the TCI state of the CSI-RS may be set to be consistent with the TCI state of the PDCCH and/or the PDSCH, thereby eliminating duration of activating the TCI state of the CSI-RS. (7) An execution time of an AGC adjustment operation overlaps with that of a fine synchronization operation, that is, total duration of the AGC adjustment operation and the fine synchronization operation may be reduced by executing the AGC adjustment operation and the fine synchronization operation in parallel. In the embodiments of this application, a SCell activation delay may be reduced in a plurality of manners, thereby improving terminal performance.

### BRIEF DESCRIPTION OF DRAWINGS

FIG. 1 is a block diagram of a wireless communication system to which embodiments of this application are applicable;

FIG. 2 is a schematic diagram of an activation delay of a known cell according to an embodiment of this application;

FIG. 3 is a schematic diagram of an activation delay of an unknown cell according to an embodiment of this application;

FIG. 4 is a first schematic flowchart of a secondary cell SCell activation method according to an embodiment of this application;

FIG. 5 is a first specific schematic flowchart of a secondary cell SCell activation method according to an embodiment of this application;

FIG. 6 is a second specific schematic flowchart of a secondary cell SCell activation method according to an embodiment of this application;

FIG. 7 is a third specific schematic flowchart of a secondary cell SCell activation method according to an embodiment of this application;

FIG. 8 is a fourth specific schematic flowchart of a secondary cell SCell activation method according to an embodiment of this application;

FIG. 9 is a fifth schematic flowchart of a secondary cell SCell activation method according to an embodiment of this application;

FIG. 10 is a second schematic flowchart of a secondary cell SCell activation method according to an embodiment of this application;

FIG. 11 is a first schematic structural diagram of a secondary cell SCell activation apparatus according to an embodiment of this application;

FIG. 12 is a second schematic structural diagram of a secondary cell SCell activation apparatus according to an embodiment of this application;

FIG. 13 is a schematic structural diagram of a communication device according to an embodiment of this application;

FIG. 14 is a schematic structural diagram of hardware of a terminal according to an embodiment of this application; and

FIG. 15 is a schematic structural diagram of hardware of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

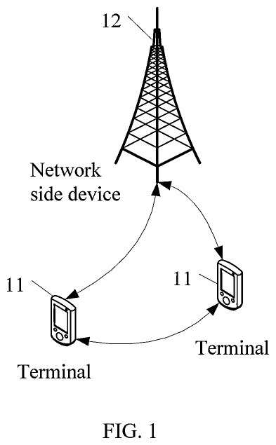

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer (Laptop Computer) or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (CNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited.

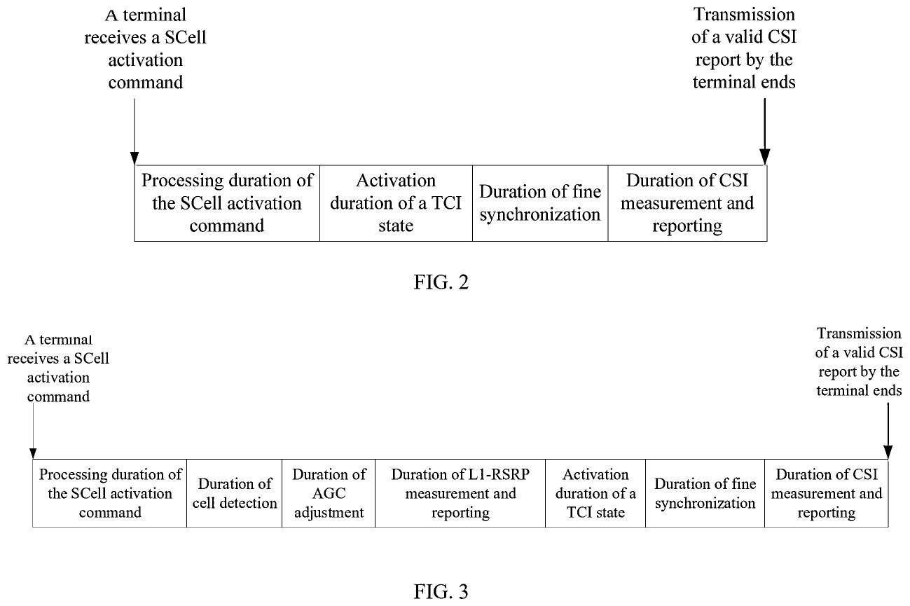

First, in a case that a SCell is a known cell, a SCell activation delay is described as follows:
As shown in FIG. 2, the SCell activation delay may include: (1) processing duration of a SCell activation command; (2) activation duration of a TCI state; (3) duration of fine synchronization; and (4) duration of CSI measurement and reporting.

For a known cell, a terminal needs to obtain a TCI state of a Physical Downlink Control Channel (PDCCH)/a Physical Downlink Shared Channel (PDSCH) by using a TCI activation command, and also needs to obtain a TCI state of a CSI Reference Signal (CSI-RS) by using a TCI activation command. If an activation time of the TCI state of the CSI-RS is too long, the SCell activation delay is too long.

Then, in a case that a SCell is an unknown cell, a SCell activation delay is described as follows:
As shown in FIG. 3, the SCell activation delay may include: (1) processing duration of a SCell activation command; (2) duration of cell detection; (3) duration of AGC adjustment; (4) duration of L1-RSRP measurement and reporting; (5) activation duration of a TCI state; (6) duration of fine synchronization; and (7) duration of CSI measurement and reporting.

For the unknown cell, in addition to the foregoing problem of the known cell, the terminal needs to perform AGC adjustment by using two measurement sampling quantities, and perform cell detection by using one measurement sampling quantity. In the case of a Frequency Range (FR) 2, the foregoing two processes further need to be multiplied by a receive beam scanning factor (a value 8) to perform beam scanning. Then, L1-RSRP measurement and reporting are required. This will cause the SCell activation delay to be too long.

With reference to the accompanying drawings, the following describes in detail the secondary cell SCell activation method provided in the embodiments of this application by using some embodiments and application scenarios thereof.

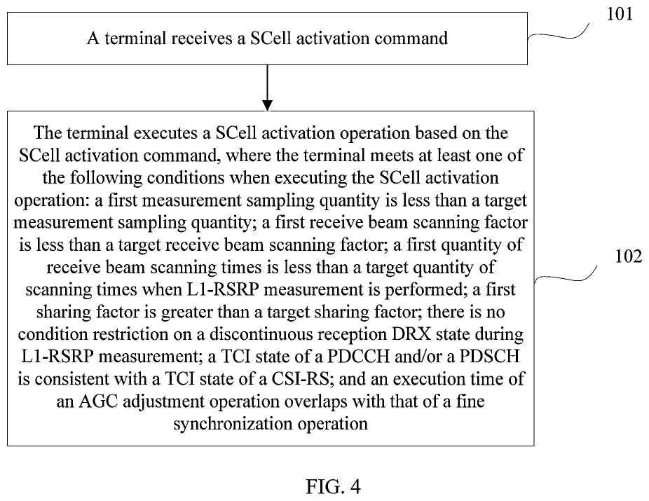

FIG. 4 is a first schematic flowchart of a secondary cell SCell activation method according to an embodiment of this application. As shown in FIG. 4, the method provided in this embodiment of this application includes the following steps.

Step 101: A terminal receives a SCell activation command.

Step 102: The terminal executes a SCell activation operation based on the SCell activation command, where the terminal meets at least one of the following conditions when executing the SCell activation operation:
a first measurement sampling quantity is less than a target measurement sampling quantity;
a first receive beam scanning factor is less than a target receive beam scanning factor;
a first quantity of receive beam scanning times is less than a target quantity of scanning times when L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a TCI state of a PDCCH and/or a PDSCH is consistent with a TCI state of a CSI-RS; and
an execution time of an AGC adjustment operation overlaps with that of a fine synchronization operation.

In step 102, for example, the terminal executes the SCell activation operation based on the SCell activation command in a case that at least one of the following conditions is met:

(1) A first measurement sampling quantity is less than a target measurement sampling quantity.

The first measurement sampling quantity is a measurement sampling quantity used in this embodiment of this application, and the target measurement sampling quantity is a preset measurement sampling quantity in a related technology. For example, the target measurement sampling quantity is 2, and the first measurement sampling quantity is 1. That is, duration of cell detection, duration of automatic gain control AGC adjustment, and duration of L1 reference signal received power L1-RSRP measurement may be reduced by reducing a measurement sampling quantity.

(2) A first receive beam scanning factor is less than a target receive beam scanning factor.

The first receive beam scanning factor is a receive beam scanning factor used in this embodiment of this application, and the target receive beam scanning factor is a preset receive beam scanning factor in a related technology. For example, the target receive beam scanning factor is 8, and the first receive beam scanning factor is 7. That is, duration of cell detection, duration of AGC adjustment, and duration of L1-RSRP measurement may be reduced by reducing a receive beam scanning factor.

(3) A first quantity of receive beam scanning times is less than a target quantity of scanning times when L1-RSRP measurement is performed.

The first quantity of receive beam scanning times is a quantity of receive beam scanning times in the process of the L1-RSRP measurement in this embodiment of this application, and the target quantity of scanning times is a preset quantity of receive beam scanning times in the process of the L1-RSRP measurement in a related technology. For example, the target quantity of scanning times is 8, and the first quantity of scanning times is 3. That is, duration of L1-RSRP measurement may be reduced by reducing a quantity of receive beam scanning times.

(4) A first sharing factor is greater than a target sharing factor, where the first sharing factor is used to indicate a priority of the L1-RSRP measurement.

The first sharing factor is a sharing factor used in this embodiment of this application, and the target sharing factor is a preset sharing factor in a related technology. For example, the target sharing factor is 1/2, and the first sharing factor is 1. That is, duration of the L1-RSRP measurement is reduced by increasing the priority of the L1-RSRP measurement.

(5) There is no condition restriction on a Discontinuous Reception (DRX) state during L1-RSRP measurement.

When the terminal performs L1-RSRP measurement, duration of the L1-RSRP measurement is affected by a DRX cycle in a related technology. When the DRX cycle is too large, the duration of the L1-RSRP measurement is lengthened, and the duration of the L1-RSRP measurement can be reduced by ignoring a condition restriction on the DRX state.

(6) A TCI state of a PDCCH and/or a PDSCH is consistent with a TCI state of a CSI-RS.

In this embodiment of this application, it is assumed that the TCI state of the CSI-RS is consistent with the TCI state of the PDCCH and/or the PDSCH. Only the TCI state of the PDCCH and/or the PDSCH needs to be activated, and duration of activating the TCI state of the CSI-RS may be eliminated.

(7) An execution time of an AGC adjustment operation overlaps with that of a fine synchronization operation. That is, the AGC adjustment operation and the fine synchronization operation may be executed in parallel. The AGC adjustment operation and the fine synchronization operation may be executed simultaneously, or the AGC adjustment operation and the fine synchronization operation may partially overlap in execution times, so that total duration of the AGC adjustment operation and the fine synchronization operation can be reduced.

In this embodiment of this application, a SCell activation delay may be reduced in the foregoing plurality of manners, to improve terminal performance.

In some embodiments, in a case that the terminal meets the following condition: the first measurement sampling quantity is less than the target measurement sampling quantity and/or the first receive beam scanning factor is less than the target receive beam scanning factor, the executing a SCell activation operation based on the SCell activation command includes:
performing, by the terminal, AGC adjustment, where duration of the AGC adjustment is positively correlated with the first measurement sampling quantity and/or the first receive beam scanning factor.

In this embodiment of this application, the duration of the AGC adjustment is positively correlated with the first measurement sampling quantity and/or the first receive beam scanning factor, that is, the duration of the AGC adjustment is reduced as the first measurement sampling quantity and/or the first receive beam scanning factor are/is reduced, so that the duration of the AGC adjustment can be reduced by reducing a measurement sampling quantity and/or a receive beam scanning factor, thereby reducing a SCell activation delay and improving terminal performance.

In some embodiments, the duration of the AGC adjustment is a sum of first duration and a product between second duration and a first value, where the first duration is duration between completion of hybrid automatic repeat request HARQ feedback based on the SCell activation command and reception of the 1st complete Synchronization Signal Block (SSB); and in the case of in-band carrier aggregation, the second duration is a maximum Synchronization Signal Block Measurement Timing Configuration (SMTC) cycle of an activated serving cell and an activated SCell indicated by the SCell activation command; or in the case of inter-band carrier aggregation, the second duration is a maximum SMTC cycle of an activated SCell indicated by the SCell activation command; and

the first value is any one of the following:
a value obtained by subtracting a second value from a product between the first measurement sampling quantity and the first receive beam scanning factor;
a value obtained by subtracting the second value from a product between the first measurement sampling quantity and the target receive beam scanning factor; and
a value obtained by subtracting the second value from a product between the target measurement sampling quantity and the first receive beam scanning factor.

In specific implementation, the duration T_{AGC} of the AGC adjustment=first duration T_{FirstSSB_MAX}+second duration T_{SMTC_MAX}×first value M. The first duration T_{FirstSSB_MAX} is duration between completion of HARQ feedback based on the SCell activation command and reception of the 1st complete SSB. In the case of in-band carrier aggregation, the second duration T_{SMTC_MAX} is a maximum SMTC cycle of an activated serving cell and an activated SCell indicated by the SCell activation command; or in the case of inter-band carrier aggregation, the second duration T_{SMTC_MA} is a maximum SMTC cycle of an activated SCell indicated by the SCell activation command; and the second value may be 1.

In a related technology, the first value M=target measurement sampling quantity x target receive beam scanning factor—1. For example, the target measurement sampling quantity is 2, the target receive beam scanning factor is 8, and the first value M=2×8−1=15.

In this embodiment of this application, a calculation manner of the first value M may include the following manners:
(1) In a case that both a measurement sampling quantity and a receive beam scanning factor are reduced, the first value M=first measurement sampling quantity x first receive beam scanning factor—1. For example, the first measurement sampling quantity is 1, the first receive beam scanning factor is 7, and the first value M=1×7−1=6, that is, the first value M is reduced from 15 to 6.
(2) In a case that a measurement sampling quantity is reduced and a receive beam scanning factor is not reduced, the first value M=first measurement sampling quantity x target receive beam scanning factor—1. For example, the first measurement sampling quantity is 1, the target receive beam scanning factor is 8, and the first value M=1×8−1=7, that is, the first value M is reduced from 15 to 7.
(3) In a case that a measurement sampling quantity is not reduced and a receive beam scanning factor is reduced, the first value M=target measurement sampling quantity × first receive beam scanning factor—1. For example, the target measurement sampling quantity is 2, the first receive beam scanning factor is 7, and the first value M=2×7−1=13, that is, the first value M is reduced from 15 to 13.

In this embodiment of this application, the first value is reduced by reducing a measurement sampling quantity and/or a receive beam scanning factor, so that the duration of the AGC adjustment can be reduced, thereby reducing a SCell activation delay and improving terminal performance.

In some embodiments, in a case that the terminal meets the following condition: the first measurement sampling quantity is less than the target measurement sampling quantity and/or the first receive beam scanning factor is less than the target receive beam scanning factor, the executing a SCell activation operation based on the SCell activation command includes:
obtaining, by the terminal, coarse timing information through cell detection, where duration of the cell detection is positively correlated with the first measurement sampling quantity and/or the first receive beam scanning factor.

In this embodiment of this application, because the duration of the cell detection is positively correlated with the first measurement sampling quantity and/or the first receive beam scanning factor, that is, the duration of the cell detection is reduced as the first measurement sampling quantity and/or the first receive beam scanning factor are/is reduced, so that the duration of the cell detection can be reduced by reducing a measurement sampling quantity and/or a receive beam scanning factor, thereby reducing a SCell activation delay and improving terminal performance.

In some embodiments, the duration of the cell detection is a product between third duration and a third value, where the third duration is an SMTC cycle of an activated SCell indicated by the SCell activation command; and

the third value is any one of the following:
a product between the first measurement sampling quantity and the first receive beam scanning factor;
a product between the first measurement sampling quantity and the target receive beam scanning factor; and
a product between the target measurement sampling quantity and the first receive beam scanning factor.

In specific implementation, the duration T_{Cell detection} of cell detection=third duration Tᵣₛ×third value N. The third duration Tᵣₛ is a SMTC cycle of an activated SCell indicated by the SCell activation command. When both a measurement sampling quantity and a receive beam scanning factor are reduced, the third value N=first measurement sampling quantity × first receive beam scanning factor; in a case that a measurement sampling quantity is reduced and a receive beam scanning factor is not reduced, the third value N=first measurement sampling quantity × target receive beam scanning factor; or in a case that a measurement sampling quantity is not reduced and a receive beam scanning factor is reduced, the third value N=target measurement sampling quantity × first receive beam scanning factor.

In this embodiment of this application, the third value is reduced by reducing a measurement sampling quantity and/or a receive beam scanning factor, so that the duration of the cell detection can be reduced, thereby reducing a SCell activation delay and improving terminal performance.

In some embodiments, in a case that the terminal meets the following condition: the first measurement sampling quantity is less than the target measurement sampling quantity and/or the first receive beam scanning factor is less than the target receive beam scanning factor, the executing a SCell activation operation based on the SCell activation command includes:
performing, by the terminal, L1-RSRP measurement, where duration of the L1-RSRP measurement is positively correlated with the first measurement sampling quantity and/or the first receive beam scanning factor.

In this embodiment of this application, because the duration of the L1-RSRP measurement is positively correlated with the first measurement sampling quantity and/or the first receive beam scanning factor, that is, the duration of the L1-RSRP measurement is reduced as the first measurement sampling quantity and/or the first receive beam scanning factor are/is reduced, the duration of the L1-RSRP measurement can be reduced by reducing a measurement sampling quantity and/or a receive beam scanning factor, thereby reducing a SCell activation delay and improving terminal performance.

In some embodiments, in a case that the terminal meets the following condition: the execution time of the AGC adjustment operation overlaps with that of the fine synchronization operation, the executing a SCell activation operation based on the SCell activation command includes:
executing, by the terminal, the fine synchronization operation when executing the AGC adjustment operation.

In this embodiment of this application, the terminal may simultaneously execute the AGC adjustment operation and the fine synchronization operation, so that total duration of the AGC adjustment operation and the fine synchronization operation can be reduced, thereby reducing a SCell activation delay and improving terminal performance.

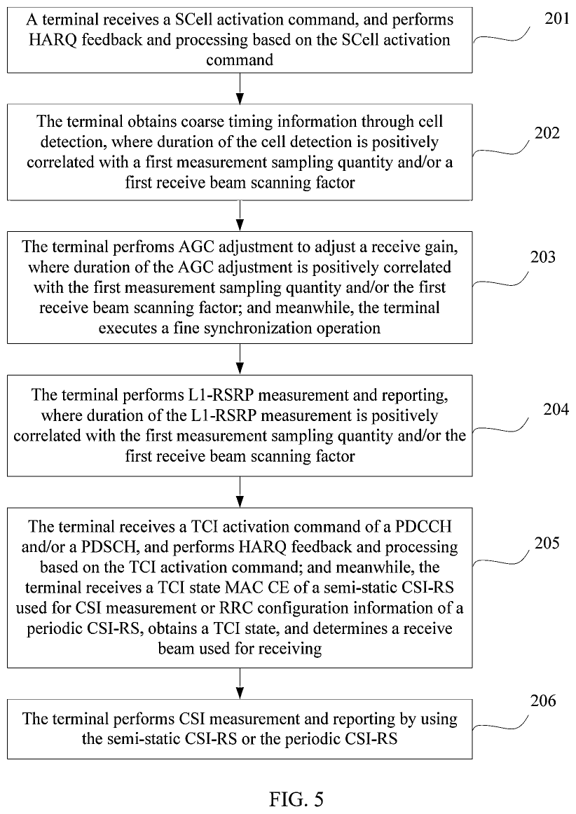

FIG. 5 is a first specific schematic flowchart of a secondary cell SCell activation method according to an embodiment of this application. As shown in FIG. 5, the method provided in this embodiment of this application includes the following steps.

Step 201: A terminal receives a SCell activation command, and performs HARQ feedback and processing based on the SCell activation command.

Step 202: The terminal obtains coarse timing information through cell detection, where duration of the cell detection is positively correlated with a first measurement sampling quantity and/or a first receive beam scanning factor.

Step 203: The terminal performs AGC adjustment to adjust a receive gain, where duration of the AGC adjustment is positively correlated with the first measurement sampling quantity and/or the first receive beam scanning factor; and meanwhile, the terminal executes a fine synchronization operation.

Step 204: The terminal performs L1-RSRP measurement and reporting, where duration of the L1-RSRP measurement is positively correlated with the first measurement sampling quantity and/or the first receive beam scanning factor.

Step 205: The terminal receives a TCI activation command of a PDCCH and/or a PDSCH, and performs HARQ feedback and processing based on the TCI activation command; and meanwhile, the terminal receives a TCI state MAC CE of a semi-static CSI-RS used for CSI measurement or RRC configuration information of a periodic CSI-RS, obtains a TCI state, and determines a receive beam used for receiving.

Step 206: The terminal performs CSI measurement and reporting by using the semi-static CSI-RS or the periodic CSI-RS.

In step 202, the duration of the cell detection is positively correlated with the first measurement sampling quantity and/or the first receive beam scanning factor. In some embodiments, the duration T_{Cell detection} of cell detection=third duration Tᵣₛ×third value N. The third duration Tᵣₛ is a SMTC cycle of an activated SCell indicated by the SCell activation command. When both a measurement sampling quantity and a receive beam scanning factor are reduced, the third value N=first measurement sampling quantity × first receive beam scanning factor; in a case that a measurement sampling quantity is reduced and a receive beam scanning factor is not reduced, the third value N=first measurement sampling quantity × target receive beam scanning factor; or in a case that a measurement sampling quantity is not reduced and a receive beam scanning factor is reduced, the third value N=target measurement sampling quantity × first receive beam scanning factor. The third value is reduced by reducing a measurement sampling quantity and/or a receive beam scanning factor, so that the duration of the cell detection can be reduced.

In step 203, the duration of the AGC adjustment is positively correlated with the first measurement sampling quantity and/or the first receive beam scanning factor. In some embodiments, the duration T_{AGC} of the AGC adjustment=first duration T_{FirstSSB_MAX}+second duration T_{SMTC_MAX}×first value M. The first duration T_{FirstSSB_MAX} is duration between completion of HARQ feedback based on the SCell activation command and reception of the 1st complete SSB. In the case of in-band carrier aggregation, the second duration T_{SMTC_MAX} is a maximum SMTC cycle of an activated serving cell and an activated SCell indicated by the SCell activation command; or in the case of inter-band carrier aggregation, the second duration T_{SMTC_MA} is a maximum SMTC cycle of an activated SCell indicated by the SCell activation command; and the second value may be 1. In a case that both a measurement sampling quantity and a receive beam scanning factor are reduced, the first value M=first measurement sampling quantity x first receive beam scanning factor —1; in a case that a measurement sampling quantity is reduced and a receive beam scanning factor is not reduced, the first value M=first measurement sampling quantity × target receive beam scanning factor —1; or in a case that a measurement sampling quantity is not reduced and a receive beam scanning factor is reduced, the first value M=target measurement sampling quantity x first receive beam scanning factor—1. The first value is reduced by reducing a measurement sampling quantity and/or a receive beam scanning factor, so that the duration of the AGC adjustment can be reduced.

In addition, the terminal simultaneously executes the AGC adjustment operation and the fine synchronization operation, so that total duration of the AGC adjustment operation and the fine synchronization operation can be reduced.

In step 204, the duration of the L1-RSRP measurement is positively correlated with the first measurement sampling quantity and/or the first receive beam scanning factor, and the duration of the L1-RSRP measurement is reduced as the first measurement sampling quantity and/or the first receive beam scanning factor are/is reduced.

It should be noted that the SCell activation method provided in this embodiment of this application is for an example in which a SCell is an unknown cell, and is applicable to a terminal that has a capability of reducing a measurement sampling quantity and/or a receive beam scanning factor. For example, the terminal may simultaneously perform receiving by using a plurality of panels, that is, a plurality of receive beams may be simultaneously scanned for implementation.

In this embodiment of this application, the duration of cell detection, the duration of AGC adjustment, and the duration of L1-RSRP measurement are reduced as the first measurement sampling quantity and/or the first receive beam scanning factor are/is reduced. In addition, the terminal simultaneously executes the AGC adjustment operation and the fine synchronization operation, so that the total duration of the AGC adjustment operation and the fine synchronization operation can be reduced. Therefore, in this embodiment of this application, by reducing the duration of cell detection, the duration of AGC adjustment, the duration of L1-RSRP measurement, and the total duration of the AGC adjustment operation and the fine synchronization operation, a SCell activation delay is reduced, thereby improving terminal performance.

In some embodiments, in a case that the terminal meets the following condition: the first quantity of receive beam scanning times is less than the target quantity of scanning times when L1-RSRP measurement is performed, the executing a SCell activation operation based on the SCell activation command includes:
performing, by the terminal, L1-RSRP measurement, where the first quantity of scanning times is less than the target quantity of scanning times, and a sum of the first quantity of scanning times and a second quantity of scanning times is greater than or equal to the target quantity of scanning times, where the first quantity of scanning times is a quantity of receive beam scanning times in a process of the L1-RSRP measurement, the second quantity of scanning times is a quantity of receive beam scanning times in a process of cell detection, and the target quantity of scanning times is a preset quantity of scanning times in a related technology.

In specific implementation, the terminal has completed the process of the cell detection before performing the L1-RSRP measurement. Because receive beam scanning has been performed in the process of the cell detection, a quantity of receive beam scanning times may be reduced by using prior information when the terminal performs the L1-RSRP measurement. The prior information herein is receive beam scanning information of the terminal in the process of the cell detection. For example, the target quantity of scanning times is 8, and the second quantity of scanning times is 8. In the related technology, the terminal needs to perform eight receive beam scanning times when performing the L1-RSRP measurement. However, because eight receive beam scanning times have been performed in the process of the cell detection, the quantity of receive beam scanning times may be reduced by using prior information of the eight receive beam scanning times when the terminal performs the L1-RSRP measurement. The first quantity of scanning times may be greater than or equal to 0 and less than 8.

In this embodiment of this application, when the terminal performs the L1-RSRP measurement, a quantity of receive beam scanning times may be reduced by using prior information of receive beam scanning in the process of the cell detection, and duration of the L1-RSRP measurement is reduced by reducing the quantity of receive beam scanning times, thereby reducing a SCell activation delay and improving terminal performance.

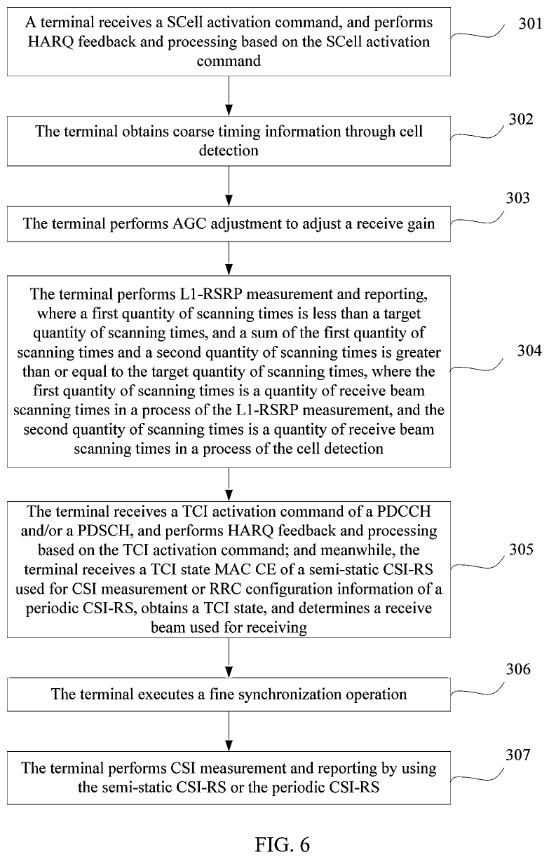

FIG. 6 is a second specific schematic flowchart of a secondary cell SCell activation method according to an embodiment of this application. As shown in FIG. 6, the method provided in this embodiment of this application includes the following steps.

Step 301: A terminal receives a SCell activation command, and performs HARQ feedback and processing based on the SCell activation command.

Step 302: The terminal obtains coarse timing information through cell detection.

Step 303: The terminal performs AGC adjustment to adjust a receive gain.

Step 304: The terminal performs L1-RSRP measurement and reporting, where a first quantity of scanning times is less than a target quantity of scanning times, and a sum of the first quantity of scanning times and a second quantity of scanning times is greater than or equal to the target quantity of scanning times, where the first quantity of scanning times is a quantity of receive beam scanning times in a process of the L1-RSRP measurement, and the second quantity of scanning times is a quantity of receive beam scanning times in a process of the cell detection.

Step 305: The terminal receives a TCI activation command of a PDCCH and/or a PDSCH, and performs HARQ feedback and processing based on the TCI activation command; and meanwhile, the terminal receives a TCI state MAC CE of a semi-static CSI-RS used for CSI measurement or RRC configuration information of a periodic CSI-RS, obtains a TCI state, and determines a receive beam used for receiving.

Step 306: The terminal executes a fine synchronization operation.

Step 307: The terminal performs CSI measurement and reporting by using the semi-static CSI-RS or the periodic CSI-RS.

For step 304, in a related technology, a quantity of times that the terminal needs to

perform receive beam scanning when performing the L1-RSRP measurement is the target quantity of scanning times. Because the terminal has completed the process of the cell detection before performing the L1-RSRP measurement, and the second quantity of receive beam scanning times has been performed in the process of the cell detection, a quantity of receive beam scanning times may be reduced by using prior information of the second quantity of receive beam scanning times when the terminal performs the L1-RSRP measurement. The first quantity of scanning times may be greater than or equal to a difference between the target quantity of scanning times and the second quantity of scanning times and is less than the target quantity of scanning times.

The SCell activation method provided in this embodiment of this application is for an example in which a SCell is an unknown cell. When the terminal performs the L1-RSRP measurement, a quantity of receive beam scanning times may be reduced by using prior information of receive beam scanning in the process of the cell detection, and duration of the L1-RSRP measurement is reduced by reducing the quantity of receive beam scanning times, thereby reducing a SCell activation delay and improving terminal performance.

In some embodiments, in a case that the terminal meets the following condition: the first sharing factor is greater than the target sharing factor, the executing a SCell activation operation based on the SCell activation command includes:
in a case that a reference signal RS used by the terminal overlaps with a measurement gap and/or an SMTC occasion, performing, by the terminal, L1-RSRP measurement based on the first sharing factor.

In specific implementation, a priority of the L1-RSRP measurement is increased by increasing a sharing factor. Even when the reference signal RS used by the terminal overlaps with the measurement gap and/or the SMTC occasion, the L1-RSRP measurement is directly performed without sharing an occasion, so that duration of the L1-RSRP measurement is reduced.

The SCell activation method provided in this embodiment of this application is for an example in which a SCell is an unknown cell. Duration of the L1-RSRP measurement is reduced by increasing the priority of the L1-RSRP measurement, thereby reducing a SCell activation delay and improving terminal performance.

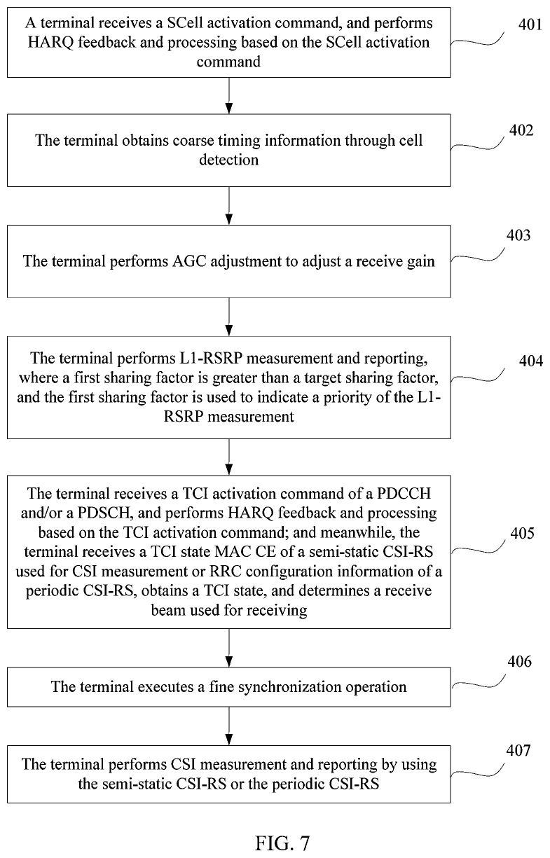

FIG. 7 is a third specific schematic flowchart of a secondary cell SCell activation method according to an embodiment of this application. As shown in FIG. 7, the method provided in this embodiment of this application includes the following steps.

Step 401: A terminal receives a SCell activation command, and performs HARQ feedback and processing based on the SCell activation command.

Step 402: The terminal obtains coarse timing information through cell detection.

Step 403: The terminal performs AGC adjustment to adjust a receive gain.

Step 404: The terminal performs L1-RSRP measurement and reporting, where a first sharing factor is greater than a target sharing factor, and the first sharing factor is used to indicate a priority of the L1-RSRP measurement.

Step 405: The terminal receives a TCI activation command of a PDCCH and/or a PDSCH, and performs HARQ feedback and processing based on the TCI activation command; and meanwhile, the terminal receives a TCI state MAC CE of a semi-static CSI-RS used for CSI measurement or RRC configuration information of a periodic CSI-RS, obtains a TCI state, and determines a receive beam used for receiving.

Step 406: The terminal executes a fine synchronization operation.

Step 407: The terminal performs CSI measurement and reporting by using the semi-static CSI-RS or the periodic CSI-RS.

For step 404, the priority of the L1-RSRP measurement is increased by increasing a sharing factor P. Even when a reference signal RS used by the terminal overlaps with a measurement gap and/or an SMTC occasion, the L1-RSRP measurement is directly performed without sharing an occasion, so that duration of the L1-RSRP measurement is reduced.

The SCell activation method provided in this embodiment of this application is for an example in which a SCell is an unknown cell. The priority of the L1-RSRP measurement is increased by increasing a sharing factor. For example, in a case that the reference signal RS used by the terminal overlaps with the measurement gap and/or the SMTC occasion, the L1-RSRP measurement is performed, so that duration of the L1-RSRP measurement is reduced, thereby reducing a SCell activation delay and improving terminal performance.

In some embodiments, in a case that the terminal meets the following condition: there is no condition restriction on the DRX state during L1-RSRP measurement, the executing a SCell activation operation based on the SCell activation command includes:
when the DRX state is an on state or an off state, performing, by the terminal, L1-RSRP measurement when receiving an RS.

In specific implementation, when the terminal performs L1-RSRP measurement, duration of the L1-RSRP measurement is affected by a DRX cycle in a related technology. When the DRX cycle is too large, the duration of the L1-RSRP measurement is lengthened, and the condition restriction on the DRX state may be ignored, that is, when the DRX state is an on state or an off state, the L1-RSRP measurement is performed, thereby reducing the duration of the L1-RSRP measurement.

In this embodiment of this application, when the DRX state is an on state or an off state, the terminal performs the L1-RSRP measurement when receiving the RS, and the condition restriction on the DRX state is ignored, so that duration of the L1-RSRP measurement can be reduced, thereby reducing a SCell activation delay and improving terminal performance.

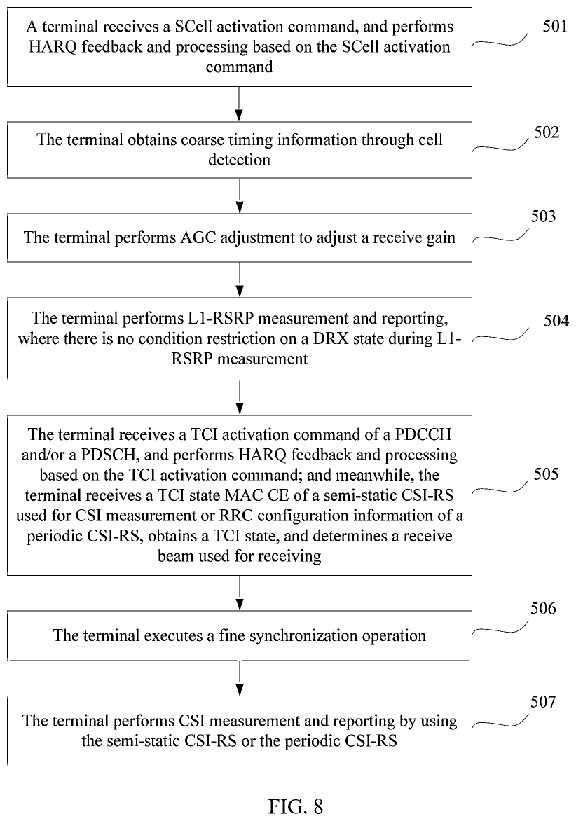

FIG. 8 is a fourth specific schematic flowchart of a secondary cell SCell activation method according to an embodiment of this application. As shown in FIG. 8, the method provided in this embodiment of this application includes the following steps.

Step 501: A terminal receives a SCell activation command, and performs HARQ feedback and processing based on the SCell activation command.

Step 502: The terminal obtains coarse timing information through cell detection.

Step 503: The terminal performs AGC adjustment to adjust a receive gain.

Step 504: The terminal performs L1-RSRP measurement and reporting, where there is no condition restriction on a DRX state during L1-RSRP measurement.

Step 505: The terminal receives a TCI activation command of a PDCCH and/or a PDSCH, and performs HARQ feedback and processing based on the TCI activation command; and meanwhile, the terminal receives a TCI state MAC CE of a semi-static CSI-RS used for CSI measurement or RRC configuration information of a periodic CSI-RS, obtains a TCI state, and determines a receive beam used for receiving.

Step 506: The terminal executes a fine synchronization operation.

Step 507: The terminal performs CSI measurement and reporting by using the semi-static CSI-RS or the periodic CSI-RS.

For step 504, when the terminal performs L1-RSRP measurement, duration of the L1-RSRP measurement is affected by a DRX cycle in a related technology. When the DRX cycle is too large, the duration of the L1-RSRP measurement is lengthened, and the condition restriction on the DRX state may be ignored. For example, when the DRX state is an on state or an off state, the L1-RSRP measurement is performed, thereby reducing the duration of the L1-RSRP measurement.

The SCell activation method provided in this embodiment of this application is for an example in which a SCell is an unknown cell. Regardless of whether the DRX state is an on state or an off state, the terminal performs the L1-RSRP measurement when receiving the RS, and the condition restriction on the DRX state is ignored, so that duration of the L1-RSRP measurement can be reduced, thereby reducing a SCell activation delay and improving terminal performance.

In some embodiments, in a case that the terminal meets the following condition: the TCI state of the PDCCH and/or the PDSCH is consistent with the TCI state of the CSI-RS, the executing a SCell activation operation based on the SCell activation command includes:
receiving, by the terminal, a TCI activation command of the PDCCH and/or the PDSCH, and performing HARQ feedback based on the TCI activation command, where the TCI activation command is used to activate the TCI state of the PDCCH and/or the PDSCH, and total activation duration of the TCI state does not include activation duration of the TCI state of the CSI-RS.

In specific implementation, the terminal assumes that the TCI state of the CSI-RS is consistent with the TCI state of the PDCCH and/or the PDSCH. Only the TCI state of the PDCCH and/or the PDSCH needs to be activated, and the total activation duration of the TCI state does not include the activation duration of the TCI state of the CSI-RS, that is, duration of activating the TCI state of the CSI-RS may be eliminated.

In this embodiment of this application, the terminal assumes that the TCI state of the CSI-RS is consistent with the TCI state of the PDCCH and/or the PDSCH. Only the TCI state of the PDCCH and/or the PDSCH needs to be activated, and duration of activating the TCI state of the CSI-RS may be eliminated, so that the total activation duration of the TCI state is reduced, thereby reducing a SCell activation delay and improving terminal performance.

In some embodiments, the total activation duration of the TCI state includes fourth duration, fifth duration, and sixth duration, where the fourth duration is duration between completion of downlink data transmission and HARQ feedback; in a case that a SCell is a known cell, the fifth duration is duration between reception of a TCI activation command of the PDDCH and/or the PDSCH and reception of the Scell activation command, or in a case that a SCell is an unknown cell, the fifth duration is duration between reception of a TCI activation command of the PDCCH and/or the PDSCH and reporting of the 1st valid L1-RSRP report; and the sixth duration is duration between completion of TCI state activation of the PDCCH and/or the PDSCH and reception of the 1st SSB used for fine synchronization.

In specific implementation, the total activation duration T_{TCI} of the TCI state=fourth duration T_{HARQ}+fifth duration T_{uncertainty_MAC}+sixth duration T_{FineTiming}+preset value (for example, 5 ms). The fourth duration T_{HARQ} is duration between completion of downlink data transmission and HARQ feedback; in a case that a SCell is a known cell, the fifth duration T_{uncertainty_MAC} is duration between reception of a TCI activation command of the PDDCH and/or the PDSCH and reception of the Scell activation command, or in a case that a SCell is an unknown cell, the fifth duration T_{uncertainty_MAC} is duration between reception of a TCI activation command of the PDCCH and/or the PDSCH and reporting of the 1st valid L1-RSRP report; and the sixth duration T_{FineTiming} is duration between completion of TCI state activation of the PDCCH and/or the PDSCH and reception of the 1st SSB used for fine synchronization.

In this embodiment of this application, the total activation duration T_{TCI} of the TCI state includes the fourth duration T_{HARQ}, the fifth duration T_{uncertainty_MAC}, and the sixth duration T_{FineTiming}, and does not include the activation duration of the TCI state of the CSI-RS, that is, duration of activating the TCI state of the CSI-RS may be eliminated, thereby reducing a SCell activation delay and improving terminal performance.

In some embodiments, in a case that the CSI-RS is a semi-static CSI-RS, the total activation duration of the TCI state does not include activation duration of a TCI state of the semi-static CSI-RS; or in a case that the CSI-RS is a periodic CSI-RS, the total activation duration of the TCI state does not include activation duration of a TCI state of the periodic CSI-RS.

In specific implementation, in a case that the CSI-RS is semi-static CSI-RS, in a related technology, the total activation duration T_{TCI} of the TCI state=3 ms +fourth duration T_{HARQ}+max (fifth duration T_{uncertainty_MAC}+sixth duration T_{FineTiming}+2 ms, seventh duration T_{uncertainty_SP}), where in a case that a SCell is a known cell, the seventh duration T_{uncertainty_SP} is duration between reception of a TCI activation command of the semi-static CSI-RS and reception of the Scell activation command; or in a case that a SCell is an unknown cell, the seventh duration T_{uncertainty_SP} is duration between reception of a TCI activation command of the semi-static CSI-RS and reporting of the 1st valid L1-RSRP report. In this embodiment of this application, in a case that the CSI-RS is a semi-static CSI-RS, the total activation duration T_{TCI} of the TCI state=fourth duration T_{HARQ}+fifth duration T_{uncertainty_MAC}+sixth duration T_{FineTiming}+ms, thereby eliminating duration of activating the TCI state of the semi-static CSI-RS, that is, the seventh duration T_{uncertainty_SP}.

For example, in a case that the CSI-RS is a periodic CSI-RS, in a related technology, the total activation duration T_{TCI} of the TCI state=max {(fourth duration T_{HARQ}+fifth duration T_{uncertainty_MAC}+5 ms+sixth duration T_{FineTiming}), (eighth duration T_{uncertainty_RRC}+ninth duration T_{RRC_delay})}, where in a case that a SCell is a known cell, the eighth duration T_{uncertainty_RRC} is duration between reception of RRC configuration information of a TCI state of the periodic CSI-RS and reception of the SCell activation command; or in a case that a SCell is an unknown cell, the eighth duration T_{uncertainty_RRC} is duration between reception of RRC configuration information of a TCI state of the periodic CSI-RS and reporting of the 1st valid L1-RSRP report; and the ninth duration T_{RRC_delay} is an RRC procedure delay. In this embodiment of this application, in a case that the CSI-RS is a periodic CSI-RS, the total activation duration T_{TCI} of the TCI state=fourth duration T_{HARQ}+fifth duration T_{uncertainty_MAC}+5 ms+sixth duration T_{FineTiming}, thereby eliminating duration of activating the TCI state of the periodic CSI-RS, that is, the eighth duration T_{uncertainty_RRC} and the ninth duration T_{RRC_delay}.

In this embodiment of this application, the total activation duration T_{TCI} of the TCI state includes the fourth duration T_{HARQ}, the fifth duration T_{uncertainty_MAC}, and the sixth duration T_{FineTiming}. In a case that the CSI-RS is a semi-static CSI-RS, the total activation duration of the TCI state eliminates the duration of activating the TCI state of the semi-static CSI-RS, that is, the seventh duration T_{uncertainty_SP}; or in a case that the CSI-RS is a periodic CSI-RS, the total activation duration of the TCI state eliminates the duration of activating the TCI state of the periodic CSI-RS, that is, the eighth duration T_{uncertainty_RRC} and the ninth duration T_{RRC_delay}. In this embodiment of this application, the total activation duration of the TCI state can be reduced, thereby reducing a SCell activation delay and improving terminal performance.

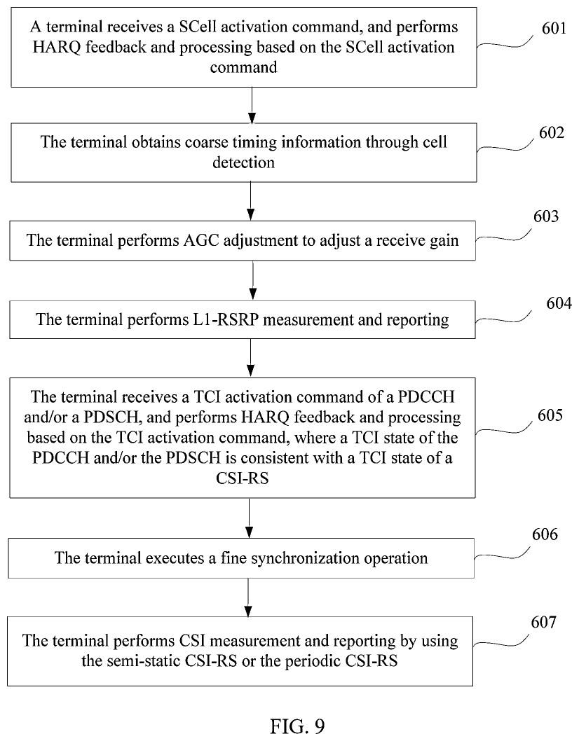

FIG. 9 is a fifth schematic flowchart of a secondary cell SCell activation method according to an embodiment of this application. As shown in FIG. 9, the method provided in this embodiment of this application includes the following steps.

Step 601: A terminal receives a SCell activation command, and performs HARQ feedback and processing based on the SCell activation command.

Step 602: The terminal obtains coarse timing information through cell detection.

Step 603: The terminal performs AGC adjustment to adjust a receive gain.

Step 604: The terminal performs L1-RSRP measurement and reporting.

Step 605: The terminal receives a TCI activation command of a PDCCH and/or a PDSCH, and performs HARQ feedback and processing based on the TCI activation command, where a TCI state of the PDCCH and/or the PDSCH is consistent with a TCI state of a CSI-RS.

Step 606: The terminal executes a fine synchronization operation.

Step 607: The terminal performs CSI measurement and reporting by using the semi-static CSI-RS or the periodic CSI-RS.

For step 605, the terminal assumes that the TCI state of the CSI-RS is consistent with the TCI state of the PDCCH and/or the PDSCH. Only the TCI state of the PDCCH and/or the PDSCH needs to be activated, and the total activation duration of the TCI state does not include the activation duration of the TCI state of the CSI-RS, that is, duration of activating the TCI state of the CSI-RS may be eliminated.

In this embodiment of this application, the terminal assumes that the TCI state of the CSI-RS is consistent with the TCI state of the PDCCH and/or the PDSCH. Only the TCI state of the PDCCH and/or the PDSCH needs to be activated, and duration of activating the TCI state of the CSI-RS may be eliminated, so that the total activation duration of the TCI state is reduced, thereby reducing a SCell activation delay and improving terminal performance.

It should be noted that the foregoing embodiment of the SCell activation method is for an example in which a SCell is an unknown cell. For a case that a SCell is a known cell, in specific implementation, the SCell activation method includes only step 601, step 605, step 606, and step 607. Total activation duration of the TCI state may be reduced by eliminating duration of activating the TCI state of the CSI-RS, thereby reducing a SCell activation delay and improving terminal performance.

The secondary cell SCell activation method provided in the embodiments of this

application may be executed by a secondary cell SCell activation apparatus. In the embodiments of this application, an example in which the secondary cell SCell activation apparatus executes the secondary cell SCell activation method is used to describe the secondary cell SCell activation apparatus provided in the embodiments of this application.

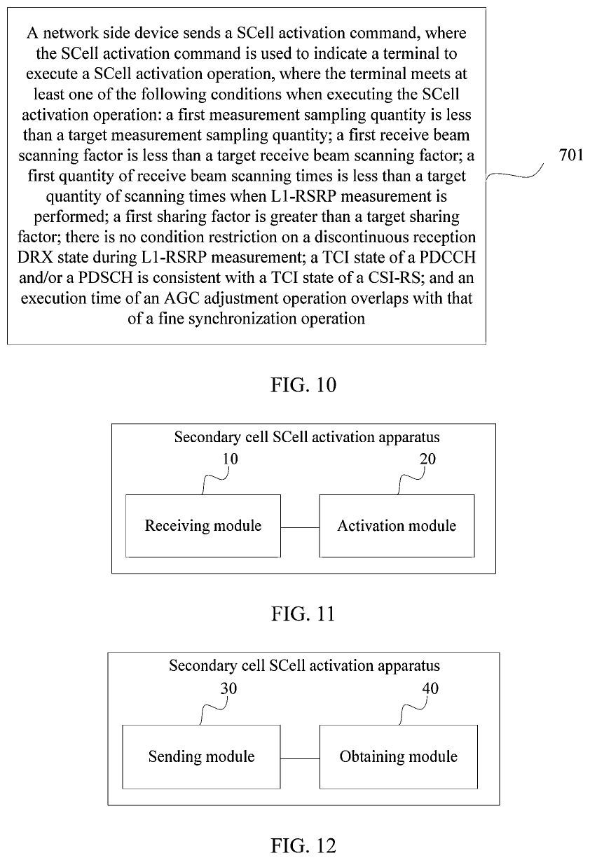

FIG. 10 is a second schematic flowchart of a secondary cell SCell activation method

according to an embodiment of this application. As shown in FIG. 10, the method provided in this embodiment of this application includes the following steps.

Step 701: A network side device sends a SCell activation command, where the SCell activation command is used to indicate a terminal to execute a SCell activation operation, where the terminal meets at least one of the following conditions when executing the SCell activation operation:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

In some embodiments, the method further includes:
obtaining, by the network side device, first configuration information based on an L1-RSRP measurement report result, and sending the first configuration information to the terminal, where the first configuration information includes configuration information of the TCI state of the PDCCH and/or the PDSCH, or includes configuration information of the TCI state of the PDCCH and/or the PDSCH and configuration information of the TCI state of the CSI-RS, where the TCI state of the PDCCH and/or the PDSCH is consistent with the TCI state of the CSI-RS.

In some embodiments, the method further includes:
sending, by the network side device, a TCI activation command to the terminal, where the TCI activation command is used to indicate the terminal to activate the TCI state of the PDCCH and/or the PDSCH.

In some embodiments, in a case that the CSI-RS is a semi-static CSI-RS, the TCI state of the PDCCH and/or the PDSCH is consistent with a TCI state of the semi-static CSI-RS; or in a case that the CSI-RS is a periodic CSI-RS, the TCI state of the PDCCH and/or the PDSCH is consistent with a TCI state of the periodic CSI-RS.

A specific implementation process and a technical effect of the method in this embodiment of this application are similar to those of the method embodiment on the terminal side. For details, refer to the detailed descriptions of the method embodiment on the terminal side. Details are not described herein again.

FIG. 11 is a first schematic structural diagram of a secondary cell SCell activation apparatus according to an embodiment of this application. As shown in FIG. 11, the secondary cell SCell activation apparatus provided in this embodiment of this application includes:
a receiving module 10, configured to receive a SCell activation command; and
an activation module 20, configured to execute a SCell activation operation based on the SCell activation command, where at least one of the following conditions is met when the SCell activation operation is executed:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

In some embodiments, the activation module 20 is configured to: in a case that the terminal meets the following condition: the first measurement sampling quantity is less than the target measurement sampling quantity and/or the first receive beam scanning factor is less than the target receive beam scanning factor, perform AGC adjustment, where duration of the AGC adjustment is positively correlated with the first measurement sampling quantity and/or the first receive beam scanning factor.

In some embodiments, the duration of the AGC adjustment is a sum of first duration and a product between second duration and a first value, where the first duration is duration between completion of hybrid automatic repeat request HARQ feedback based on the SCell activation command and reception of the 1st complete synchronization signal block SSB; and in the case of in-band carrier aggregation, the second duration is a maximum SMTC cycle of an activated serving cell and an activated SCell indicated by the SCell activation command; or in the case of inter-band carrier aggregation, the second duration is a maximum SMTC cycle of an activated SCell indicated by the SCell activation command; and
the first value is any one of the following:
a value obtained by subtracting a second value from a product between the first measurement sampling quantity and the first receive beam scanning factor;
a value obtained by subtracting the second value from a product between the first measurement sampling quantity and the target receive beam scanning factor; and
a value obtained by subtracting the second value from a product between the target measurement sampling quantity and the first receive beam scanning factor.

In some embodiments, the activation module 20 is configured to: in a case that the terminal meets the following condition: the first measurement sampling quantity is less than the target measurement sampling quantity and/or the first receive beam scanning factor is less than the target receive beam scanning factor, obtain coarse timing information through cell detection, where duration of the cell detection is positively correlated with the first measurement sampling quantity and/or the first receive beam scanning factor.

In some embodiments, the duration of the cell detection is a product between third duration and a third value, where the third duration is an SMTC cycle of an activated SCell indicated by the SCell activation command; and
the third value is any one of the following:
a product between the first measurement sampling quantity and the first receive beam scanning factor;
a product between the first measurement sampling quantity and the target receive beam scanning factor; and
a product between the target measurement sampling quantity and the first receive beam scanning factor.

In some embodiments, the activation module 20 is configured to: in a case that the terminal meets the following condition: the first measurement sampling quantity is less than the target measurement sampling quantity and/or the first receive beam scanning factor is less than the target receive beam scanning factor, perform L1-RSRP measurement, where duration of the L1-RSRP measurement is positively correlated with the first measurement sampling quantity and/or the first receive beam scanning factor.

In some embodiments, the activation module 20 is configured to: in a case that the terminal meets the following condition: the first quantity of receive beam scanning times is less than the target quantity of scanning times when L1-RSRP measurement is performed, perform L1-RSRP measurement, where the first quantity of scanning times is less than the target quantity of scanning times, and a sum of the first quantity of scanning times and a second quantity of scanning times is greater than or equal to the target quantity of scanning times, where the first quantity of scanning times is a quantity of receive beam scanning times in a process of the L1-RSRP measurement, and the second quantity of scanning times is a quantity of receive beam scanning times in a process of cell detection.

In some embodiments, the activation module 20 is configured to: in a case that the terminal meets the following condition: the first sharing factor is greater than the target sharing factor and a reference signal RS used by the terminal overlaps with a measurement gap and/or an SMTC occasion, perform L1-RSRP measurement based on the first sharing factor.

In some embodiments, the activation module 20 is configured to: in a case that the

terminal meets the following condition: there is no condition restriction on the discontinuous reception DRX state during L1-RSRP measurement, when the DRX state is an on state or an off state, perform L1-RSRP measurement when an RS is received.

In some embodiments, the activation module 20 is configured to: in a case that the terminal meets the following condition: the TCI state of the PDCCH and/or the PDSCH is consistent with the TCI state of the CSI-RS, receive a TCI activation command of the PDCCH and/or the PDSCH, and performing HARQ feedback based on the TCI activation command, where the TCI activation command is used to activate the TCI state of the PDCCH and/or the PDSCH, and total activation duration of the TCI state does not include activation duration of the TCI state of the CSI-RS.

In some embodiments, the total activation duration of the TCI state includes fourth duration, fifth duration, and sixth duration, where the fourth duration is duration between completion of downlink data transmission and HARQ feedback; in a case that a SCell is a known cell, the fifth duration is duration between reception of a TCI activation command of the PDDCH and/or the PDSCH and reception of the Scell activation command, or in a case that a SCell is an unknown cell, the fifth duration is duration between reception of a TCI activation command of the PDCCH and/or the PDSCH and reporting of the 1st valid L1-RSRP report; and the sixth duration is duration between completion of TCI state activation of the PDCCH and/or the PDSCH and reception of the 1st SSB used for fine synchronization.

In some embodiments, in a case that the CSI-RS is a semi-static CSI-RS, the total activation duration of the TCI state does not include activation duration of a TCI state of the semi-static CSI-RS; or in a case that the CSI-RS is a periodic CSI-RS, the total activation duration of the TCI state does not include activation duration of a TCI state of the periodic CSI-RS.

In some embodiments, the activation module 20 is configured to: in a case that the terminal meets the following condition: the execution time of the AGC adjustment operation overlaps with that of the fine synchronization operation, execute the fine synchronization operation when executing the AGC adjustment operation.

The apparatus in this embodiment of this application may be configured to execute the method in any one of the foregoing method embodiments on the terminal side. A specific implementation process and a technical effect of the apparatus are similar to those of the method embodiment on the terminal side. For details, refer to the detailed descriptions of the method embodiment on the terminal side. Details are not described herein again.

FIG. 12 is a second schematic structural diagram of a secondary cell SCell activation apparatus according to an embodiment of this application. As shown in FIG. 12, the secondary cell SCell activation apparatus provided in this embodiment of this application includes:
a sending module 30, configured to send a SCell activation command, where the SCell activation command is used to indicate a terminal to execute a SCell activation operation, where the terminal meets at least one of the following conditions when executing the SCell activation operation:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

In some embodiments, the apparatus further includes:
an obtaining module 40, configured to: obtain first configuration information based on an L1-RSRP measurement report result, and send the first configuration information to the terminal, where the first configuration information includes configuration information of the TCI state of the PDCCH and/or the PDSCH, or includes configuration information of the TCI state of the PDCCH and/or the PDSCH and configuration information of the TCI state of the CSI-RS, where the TCI state of the PDCCH and/or the PDSCH is consistent with the TCI state of the CSI-RS.

In some embodiments, the sending module 30 is further configured to:
send a TCI activation command to the terminal, where the TCI activation command is used to indicate the terminal to activate the TCI state of the PDCCH and/or the PDSCH.

In some embodiments, in a case that the CSI-RS is a semi-static CSI-RS, the TCI state of the PDCCH and/or the PDSCH is consistent with a TCI state of the semi-static CSI-RS; or in a case that the CSI-RS is a periodic CSI-RS, the TCI state of the PDCCH and/or the PDSCH is consistent with a TCI state of the periodic CSI-RS.

The apparatus in this embodiment of this application may be configured to execute the method in any one of the foregoing method embodiments on the network side device side. A specific implementation process and a technical effect of the apparatus are similar to those of the method embodiment on the network side device side. For details, refer to the detailed descriptions of the method embodiment on the network side device side. Details are not described herein again.

The secondary cell SCell activation apparatus in this embodiment of this application may be an electronic device, or may be a component in the electronic device, such as an integrated circuit or a chip. The electronic device may be a terminal, or another device other than the terminal. For example, the terminal may include but is not limited to the type of the terminal 11 listed above. The another device may be a server, a Network Attached Storage (NAS), a Personal Computer (PC), a television (TV), a teller machine, or a self-service machine. This is not specifically limited in this embodiment of this application.

The secondary cell SCell activation apparatus provided in this embodiment of this application may be an apparatus with an operating system. The operating system may be an Android operating system, may be an iOS operating system, or may be another possible operating system. This is not specifically limited in this embodiment of this application.

The secondary cell SCell activation apparatus provided in this embodiment of this application can implement the processes implemented in the method embodiments in FIG. 4 to FIG. 12, and achieve a same technical effect. To avoid repetition, details are not described herein again.

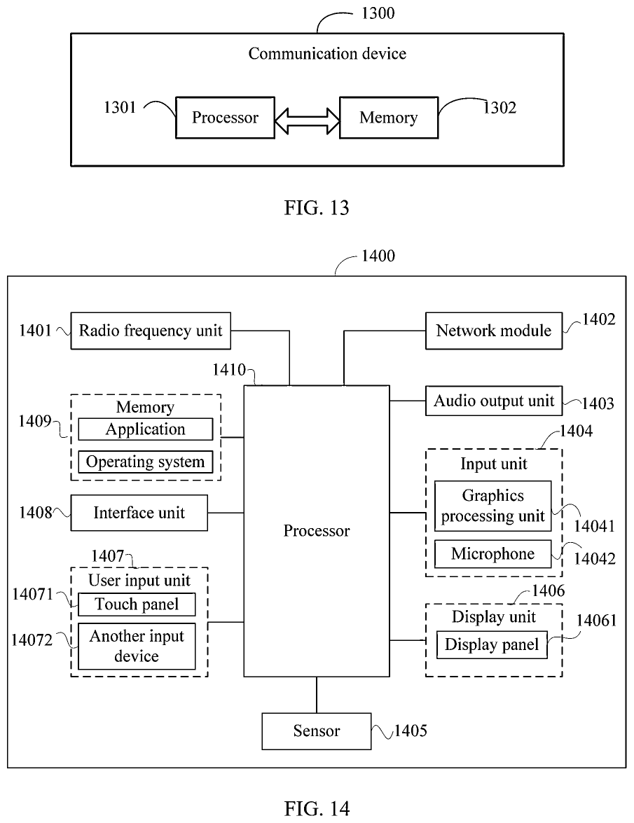

In some embodiments, as shown in FIG. 13, an embodiment of this application further provides a communication device 1300, including a processor 1301 and a memory 1302. The memory 1302 stores a program or an instruction that can be run on the processor 1301. For example, when the communication device 1100 is a terminal, the program or the instruction is executed by the processor 1301 to implement the steps of the foregoing secondary cell SCell activation method embodiment, and a same technical effect can be achieved. When the communication device 1100 is a network ide device, the program or the instruction is executed by the processor 1301 to implement the processes of the foregoing secondary cell SCell activation method embodiment, and a same technical effect can be achieved. To avoid repetition, details are not described herein again.

An embodiment of this application further provides a terminal, including a processor and a communication interface. The communication interface is configured to receive a SCell activation command, and the processor is configured to execute a SCell activation operation based on the SCell activation command, where at least one of the following conditions is met when the SCell activation operation is executed: a first measurement sampling quantity is less than a target measurement sampling quantity; a first receive beam scanning factor is less than a target receive beam scanning factor; a first quantity of receive beam scanning times is less than a target quantity of scanning times when L1 reference signal received power L1-RSRP measurement is performed; a first sharing factor is greater than a target sharing factor, where the first sharing factor is used to indicate a priority of the L1-RSRP measurement; there is no condition restriction on a discontinuous reception DRX state during L1-RSRP measurement; a transmission configuration indicator TCI state of a physical downlink control channel PDCCH and/or a physical downlink shared channel PDSCH is consistent with a TCI state of a channel state information-reference signal CSI-RS; and an execution time of an automatic gain control AGC adjustment operation overlaps with that of a fine synchronization operation. This terminal embodiment corresponds to the foregoing method embodiment on the terminal side. Each implementation process and implementation of the foregoing method embodiment may be applicable to this terminal embodiment, and a same technical effect can be achieved. In some embodiments, FIG. 14 is a schematic structural diagram of hardware of a terminal according to an embodiment of this application.

The terminal 1400 includes but is not limited to components such as a radio frequency unit 1401, a network module 1402, an audio output unit 1403, an input unit 1404, a sensor 1405, a display unit 1406, a user input unit 1407, an interface unit 1408, a memory 1409, and a processor 1410.

A person skilled in the art can understand that the terminal 1400 may further include the power supply (for example, a battery) that supplies power to each component. The power supply may be logically connected to the processor 1410 by using a power supply management system, so as to manage functions such as charging, discharging, and power consumption by using the power supply management system. The terminal structure shown in FIG. 14 constitutes no limitation on the terminal, and the terminal may include more or fewer components than those shown in the figure, or combine some components, or have different component arrangements. Details are not described herein.

It should be understood that, in this embodiment of this application, the input unit 1404 may include a Graphics Processing Unit (GPU) 14041 and a microphone 14042, and the graphics processing unit 14041 processes image data of a still image or a video that is obtained by an image capturing apparatus (for example, a camera) in a video capturing mode or an image capturing mode. The display unit 1406 may include a display panel 14061. The display panel 14061 may be configured in a form such as a liquid crystal display or an organic light-emitting diode. The user input unit 1407 includes at least one of a touch panel 14071 and another input device 14072. The touch panel 14071 is also referred to as a touchscreen. The touch panel 14071 may include two parts: a touch detection apparatus and a touch controller. The another input device 14072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1401 may transmit the downlink data to the processor 1410 for processing. In addition, the radio frequency unit 1401 may send uplink data to the network side device. Usually, the radio frequency unit 1401 includes but is not limited to an antenna, an amplifier, a transceiver, a coupler, a low noise amplifier, a duplexer, and the like.

The memory 1409 may be configured to store a software program or an instruction and various data. The memory 1409 may mainly include a first storage area for storing a program or an instruction and a second storage area for storing data. The first storage area may store an operating system, and an application or an instruction required by at least one function (for example, a sound playing function or an image playing function). In addition, the memory 1409 may be a volatile memory or a non-volatile memory, or the memory 1409 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1409 in this embodiment of this application includes but is not limited to these memories and a memory of any other proper type.

The processor 1410 may include one or more processing units. In some embodiments, an application processor and a modem processor are integrated into the processor 1410. The application processor mainly processes an operating system, a user interface, an application, and the like. The modem processor mainly processes a wireless communication signal, for example, a baseband processor. It can be understood that, in some embodiments, the modem processor may not be integrated into the processor 1410.

The radio frequency unit 1401 is configured to receive a SCell activation command.

The processor 1410 is configured to execute a SCell activation operation based on the SCell activation command, where the terminal meets at least one of the following conditions when executing the SCell activation operation:
a first measurement sampling quantity is less than a target measurement sampling quantity;
a first receive beam scanning factor is less than a target receive beam scanning factor;
a first quantity of receive beam scanning times is less than a target quantity of scanning times when L1 reference signal received power L1-RSRP measurement is performed;
a first sharing factor is greater than a target sharing factor, where the first sharing factor is used to indicate a priority of the L1-RSRP measurement;
there is no condition restriction on a discontinuous reception DRX state during L1-RSRP measurement;
a transmission configuration indicator TCI state of a physical downlink control channel PDCCH and/or a physical downlink shared channel PDSCH is consistent with a TCI state of a channel state information-reference signal CSI-RS; and
an execution time of an automatic gain control AGC adjustment operation overlaps with that of a fine synchronization operation.

In the foregoing implementation, a SCell activation delay may be reduced in the foregoing plurality of manners, to improve terminal performance.

In some embodiments, the processor 1410 is configured to:
in a case that the terminal meets the following condition: the first measurement sampling quantity is less than the target measurement sampling quantity and/or the first receive beam scanning factor is less than the target receive beam scanning factor, perform AGC adjustment, where duration of the AGC adjustment is positively correlated with the first measurement sampling quantity and/or the first receive beam scanning factor.

In the foregoing implementation, the duration of the AGC adjustment is positively correlated with the first measurement sampling quantity and/or the first receive beam scanning factor, that is, the duration of the AGC adjustment is reduced as the first measurement sampling quantity and/or the first receive beam scanning factor are/is reduced, so that the duration of the AGC adjustment can be reduced by reducing a measurement sampling quantity and/or a receive beam scanning factor, thereby reducing a SCell activation delay and improving terminal performance.

In some embodiments, the duration of the AGC adjustment is a sum of first duration and a product between second duration and a first value, where the first duration is duration between completion of hybrid automatic repeat request HARQ feedback based on the SCell activation command and reception of the 1st complete synchronization signal block SSB; and in the case of in-band carrier aggregation, the second duration is a maximum SMTC cycle of an activated serving cell and an activated SCell indicated by the SCell activation command; or in the case of inter-band carrier aggregation, the second duration is a maximum SMTC cycle of an activated SCell indicated by the SCell activation command; and
the first value is any one of the following:
a value obtained by subtracting a second value from a product between the first measurement sampling quantity and the first receive beam scanning factor;
a value obtained by subtracting the second value from a product between the first measurement sampling quantity and the target receive beam scanning factor; and
a value obtained by subtracting the second value from a product between the target measurement sampling quantity and the first receive beam scanning factor.

In the foregoing implementation, the first value is reduced by reducing a measurement sampling quantity and/or a receive beam scanning factor, so that the duration of the AGC adjustment can be reduced, thereby reducing a SCell activation delay and improving terminal performance.

In some embodiments, the processor 1410 is configured to:
in a case that the terminal meets the following condition: the first measurement sampling quantity is less than the target measurement sampling quantity and/or the first receive beam scanning factor is less than the target receive beam scanning factor, obtain coarse timing information through cell detection, where duration of the cell detection is positively correlated with the first measurement sampling quantity and/or the first receive beam scanning factor.

In the foregoing implementation, because the duration of the cell detection is positively correlated with the first measurement sampling quantity and/or the first receive beam scanning factor, that is, the duration of the cell detection is reduced as the first measurement sampling quantity and/or the first receive beam scanning factor are/is reduced, so that the duration of the cell detection can be reduced by reducing a measurement sampling quantity and/or a receive beam scanning factor, thereby reducing a SCell activation delay and improving terminal performance.

In some embodiments, the duration of the cell detection is a product between third duration and a third value, where the third duration is an SMTC cycle of an activated SCell indicated by the SCell activation command; and
the third value is any one of the following:
a product between the first measurement sampling quantity and the first receive beam scanning factor;
a product between the first measurement sampling quantity and the target receive beam scanning factor; and
a product between the target measurement sampling quantity and the first receive beam scanning factor.

In the foregoing implementation, the third value is reduced by reducing a measurement sampling quantity and/or a receive beam scanning factor, so that the duration of the cell detection can be reduced, thereby reducing a SCell activation delay and improving terminal performance.

In some embodiments, the processor 1410 is configured to:
in a case that the terminal meets the following condition: the first measurement sampling quantity is less than the target measurement sampling quantity and/or the first receive beam scanning factor is less than the target receive beam scanning factor, perform L1-RSRP measurement, where duration of the L1-RSRP measurement is positively correlated with the first measurement sampling quantity and/or the first receive beam scanning factor.

In the foregoing implementation, because the duration of the L1-RSRP measurement is positively correlated with the first measurement sampling quantity and/or the first receive beam scanning factor, that is, the duration of the L1-RSRP measurement is reduced as the first measurement sampling quantity and/or the first receive beam scanning factor are/is reduced, the duration of the L1-RSRP measurement can be reduced by reducing a measurement sampling quantity and/or a receive beam scanning factor, thereby reducing a SCell activation delay and improving terminal performance.

In some embodiments, the processor 1410 is configured to:
in a case that the terminal meets the following condition: the first quantity of receive beam scanning times is less than the target quantity of scanning times when L1-RSRP measurement is performed, perform L1-RSRP measurement, where the first quantity of scanning times is less than the target quantity of scanning times, and a sum of the first quantity of scanning times and a second quantity of scanning times is greater than or equal to the target quantity of scanning times, where the first quantity of scanning times is a quantity of receive beam scanning times in a process of the L1-RSRP measurement, and the second quantity of scanning times is a quantity of receive beam scanning times in a process of cell detection.

In the foregoing implementation, when the terminal performs the L1-RSRP measurement, a quantity of receive beam scanning times may be reduced by using prior information of receive beam scanning in the process of the cell detection, and duration of the L1-RSRP measurement is reduced by reducing the quantity of receive beam scanning times, thereby reducing a SCell activation delay and improving terminal performance.

In some embodiments, the processor 1410 is configured to:
in a case that the terminal meets the following condition: the first sharing factor is greater than the target sharing factor and a reference signal RS used by the terminal overlaps with a measurement gap and/or an SMTC occasion, perform L1-RSRP measurement based on the first sharing factor.

In the foregoing implementation, duration of the L1-RSRP measurement is reduced by increasing the priority of the L1-RSRP measurement, thereby reducing a SCell activation delay and improving terminal performance.

In some embodiments, the processor 1410 is configured to:
in a case that the terminal meets the following condition: there is no condition restriction on the discontinuous reception DRX state during L1-RSRP measurement, when the DRX state is an on state or an off state, perform L1-RSRP measurement when an RS is received.

In the foregoing implementation, when the DRX state is an on state or an off state, the terminal performs the L1-RSRP measurement when receiving the RS, and the condition restriction on the DRX state is ignored, so that duration of the L1-RSRP measurement is reduced, thereby reducing a SCell activation delay and improving terminal performance.

In some embodiments, the processor 1410 is configured to:
in a case that the terminal meets the following condition: the TCI state of the PDCCH and/or the PDSCH is consistent with the TCI state of the CSI-RS, receive a TCI activation command of the PDCCH and/or the PDSCH, and performing HARQ feedback based on the TCI activation command, where the TCI activation command is used to activate the TCI state of the PDCCH and/or the PDSCH, and total activation duration of the TCI state does not include activation duration of the TCI state of the CSI-RS.

In the foregoing implementation, the terminal assumes that the TCI state of the CSI-RS is consistent with the TCI state of the PDCCH and/or the PDSCH. Only the TCI state of the PDCCH and/or the PDSCH needs to be activated, and duration of activating the TCI state of the CSI-RS may be eliminated, so that the total activation duration of the TCI state is reduced, thereby reducing a SCell activation delay and improving terminal performance.

In some embodiments, the total activation duration of the TCI state includes fourth duration, fifth duration, and sixth duration, where the fourth duration is duration between completion of downlink data transmission and HARQ feedback; in a case that a SCell is a known cell, the fifth duration is duration between reception of a TCI activation command of the PDDCH and/or the PDSCH and reception of the Scell activation command, or in a case that a SCell is an unknown cell, the fifth duration is duration between reception of a TCI activation command of the PDCCH and/or the PDSCH and reporting of the 1st valid L1-RSRP report; and the sixth duration is duration between completion of TCI state activation of the PDCCH and/or the PDSCH and reception of the 1st SSB used for fine synchronization.

In the foregoing implementation, the total activation duration T_{TCI} of the TCI state includes the fourth duration, the fifth duration, and the sixth duration, and does not include activation duration of the TCI state of the CSI-RS, that is, duration of activating the TCI state of the CSI-RS may be eliminated, thereby reducing a SCell activation delay and improving terminal performance.

In some embodiments, in a case that the CSI-RS is a semi-static CSI-RS, the total activation duration of the TCI state does not include activation duration of a TCI state of the semi-static CSI-RS; or in a case that the CSI-RS is a periodic CSI-RS, the total activation duration of the TCI state does not include activation duration of a TCI state of the periodic CSI-RS.

In the foregoing implementation, the total activation duration T_{TCI} of the TCI state includes the fourth duration, the fifth duration, and the sixth duration. In a case that the CSI-RS is a semi-static CSI-RS, the total activation duration of the TCI state eliminates duration of activating the TCI state of the semi-static CSI-RS; or in a case that the CSI-RS is a periodic CSI-RS, the total activation duration of the TCI state eliminates duration of activating the TCI state of the periodic CSI-RS, so that the total activation duration of the TCI state can be reduced, thereby reducing a SCell activation delay and improving terminal performance.

In some embodiments, the processor 1410 is configured to:
in a case that the terminal meets the following condition: the execution time of the AGC adjustment operation overlaps with that of the fine synchronization operation, execute the fine synchronization operation when executing the AGC adjustment operation.

In the foregoing implementation, the terminal may simultaneously execute the AGC adjustment operation and the fine synchronization operation, so that total duration of the AGC adjustment operation and the fine synchronization operation can be reduced, thereby reducing a SCell activation delay and improving terminal performance.

An embodiment of this application further provides a network side device, including a processor and a communication interface. The communication interface is configured to send a SCell activation command, where the SCell activation command is used to indicate a terminal to execute a SCell activation operation, where the terminal meets at least one of the following conditions when executing the SCell activation operation: a first measurement sampling quantity is less than a target measurement sampling quantity; a first receive beam scanning factor is less than a target receive beam scanning factor; a first quantity of receive beam scanning times is less than a target quantity of scanning times when L1 reference signal received power L1-RSRP measurement is performed; a first sharing factor is greater than a target sharing factor, where the first sharing factor is used to indicate a priority of the L1-RSRP measurement; there is no condition restriction on a discontinuous reception DRX state during L1-RSRP measurement; a transmission configuration indicator TCI state of a physical downlink control channel PDCCH and/or a physical downlink shared channel PDSCH is consistent with a TCI state of a channel state information-reference signal CSI-RS; and an execution time of an automatic gain control AGC adjustment operation overlaps with that of a fine synchronization operation. This network side device embodiment corresponds to the foregoing method embodiment of the network side device. Each implementation process and implementation of the foregoing method embodiment may be applicable to this network side device embodiment, and a same technical effect can be achieved.

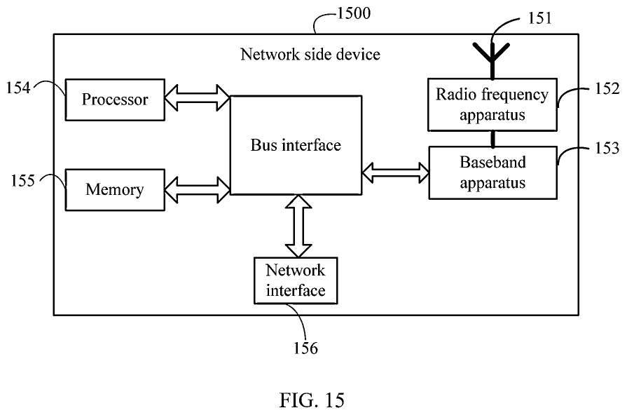

In some embodiments, an embodiment of this application further provides a network side device. As shown in FIG. 15, the network side device 1500 includes an antenna 151, a radio frequency apparatus 152, a baseband apparatus 153, a processor 154, and a memory 155. The antenna 151 is connected to the radio frequency apparatus 152. In an uplink direction, the radio frequency apparatus 152 receives information by using the antenna 151, and sends the received information to the baseband apparatus 153 for processing. In a downlink direction, the baseband apparatus 153 processes information that needs to be sent, and sends processed information to the radio frequency apparatus 152. The radio frequency apparatus 152 processes the received information, and sends processed information by using the antenna 151.

In the foregoing embodiment, the method performed by the network side device may be implemented in the baseband apparatus 153. The baseband apparatus 153 includes a baseband processor.

The baseband apparatus 153 may include, for example, at least one baseband board, where a plurality of chips are disposed on the baseband board. As shown in FIG. 15, one chip is, for example, the baseband processor, is connected to the memory 155 through a bus interface, to invoke a program in the memory 155 to perform the operations of the network device shown in the foregoing method embodiment.

The network side device may further include a network interface 156, and the

interface is, for example, a Common Public Radio Interface (CPRI).

In some embodiments, the network side device 1500 in this embodiment of the present disclosure further includes an instruction or a program that is stored in the memory 155 and that can be run on the processor 154. The processor 154 invokes the instruction or the program in the memory 155 to perform the method performed by the modules shown in FIG. 12, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing secondary cell SCell activation method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing secondary cell SCell activation method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing secondary cell SCell activation method embodiment, and a same technical effect can be achieved. To avoid repetition, details are not described herein again.

An embodiment of this application further provides a communication system, including a terminal and a network side device. The terminal may be configured to perform the steps of the foregoing secondary cell SCell activation method, and the network side device may be configured to perform the steps of the foregoing secondary cell SCell activation method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is an example implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A secondary cell (Scell) activation method, comprising:
receiving, by a terminal, a SCell activation command, and executing a SCell activation operation based on the SCell activation command, wherein the terminal meets at least one of the following conditions when executing the SCell activation operation:
a first receive beam scanning factor is less than a target receive beam scanning factor;
a first quantity of receive beam scanning times is less than a target quantity of scanning times when L1 reference signal received power (L1-RSRP) measurement is performed; or
there is no condition restriction on a discontinuous reception (DRX) state during L1-RSRP measurement.

2. The SCell activation method according to claim 1, wherein when the terminal meets the following condition: the first receive beam scanning factor is less than the target receive beam scanning factor, the executing the SCell activation operation based on the SCell activation command comprises:
performing, by the terminal, Automatic Gain Control (AGC) adjustment, wherein duration of the AGC adjustment is positively correlated with the first receive beam scanning factor.

3. The SCell activation method according to claim 2, wherein the duration of the AGC adjustment is a sum of first duration and a product between second duration and a first value, wherein
the first duration is duration between completion of hybrid automatic repeat request (HARQ) feedback based on the SCell activation command and reception of a first complete synchronization signal block (SSB);
with in-band carrier aggregation, the second duration is a maximum synchronization signal block measurement timing configuration (SMTC) cycle of an activated serving cell and an activated SCell indicated by the SCell activation command; or with inter-band carrier aggregation, the second duration is a maximum SMTC cycle of an activated SCell indicated by the SCell activation command; and
the first value is any one of the following:
a value obtained by subtracting a second value from a product between the first measurement sampling quantity and the first receive beam scanning factor;
a value obtained by subtracting the second value from a product between the first measurement sampling quantity and the target receive beam scanning factor; or
a value obtained by subtracting the second value from a product between the target measurement sampling quantity and the first receive beam scanning factor.

4. The SCell activation method according to claim 1, wherein when the terminal meets the following condition: the first receive beam scanning factor is less than the target receive beam scanning factor, the executing the SCell activation operation based on the SCell activation command comprises:
obtaining, by the terminal, coarse timing information through cell detection, wherein duration of the cell detection is positively correlated with a first measurement sampling quantity or the first receive beam scanning factor.

5. The SCell activation method according to claim 4, wherein the duration of the cell detection is a product between third duration and a third value, wherein the third duration is an SMTC cycle of an activated SCell indicated by the SCell activation command; and
the third value is any one of the following:
a product between the first measurement sampling quantity and the first receive beam scanning factor;
a product between the first measurement sampling quantity and the target receive beam scanning factor; or
a product between the target measurement sampling quantity and the first receive beam scanning factor.

6. The SCell activation method according to claim 1, wherein when the terminal meets the following condition: the first receive beam scanning factor is less than the target receive beam scanning factor, the executing the SCell activation operation based on the SCell activation command comprises:
performing, by the terminal, L1-RSRP measurement, wherein duration of the L1-RSRP measurement is positively correlated with a first measurement sampling quantity or the first receive beam scanning factor.

7. The SCell activation method according to claim 1, wherein when the terminal meets the following condition: the first quantity of receive beam scanning times is less than the target quantity of scanning times when L1-RSRP measurement is performed, the executing the SCell activation operation based on the SCell activation command comprises:
performing, by the terminal, L1-RSRP measurement, wherein the first quantity of scanning times is less than the target quantity of scanning times, and a sum of the first quantity of scanning times and a second quantity of scanning times is greater than or equal to the target quantity of scanning times, wherein the first quantity of scanning times is a quantity of receive beam scanning times in a process of the L1-RSRP measurement, and the second quantity of scanning times is a quantity of receive beam scanning times in a process of cell detection.

8. The SCell activation method according to claim 1, wherein when the terminal meets the following condition: there is no condition restriction on the discontinuous reception DRX state during L1-RSRP measurement, the executing the SCell activation operation based on the SCell activation command comprises:
when the DRX state is an on state or an off state, performing, by the terminal, the L1-RSRP measurement when receiving an RS.

9. A secondary cell (SCell) activation method, comprising:
sending, by a network side device, a SCell activation command, wherein the SCell activation command is used to indicate a terminal to execute a SCell activation operation, wherein the terminal meets at least one of the following conditions when executing the SCell activation operation:
a first receive beam scanning factor is less than a target receive beam scanning factor;
a first quantity of receive beam scanning times is less than a target quantity of scanning times when L1 reference signal received power (L1-RSRP) measurement is performed; or
there is no condition restriction on a discontinuous reception (DRX) state during L1-RSRP measurement.

10. The SCell activation method according to claim 9, further comprising:
obtaining, by the network side device, first configuration information based on an L1-RSRP measurement report result, and sending the first configuration information to the terminal,
wherein the first configuration information comprises configuration information of the Transmission Configuration Indicator (TCI) state of a Physical Downlink Control Channel (PDCCH) or a Physical Downlink Shared Channel (PDSCH), or comprises configuration information of the TCI state of the PDCCH or the PDSCH and configuration information of the TCI state of a channel state information-reference signal (CSI-RS), wherein the TCI state of the PDCCH or the PDSCH is consistent with the TCI state of the CSI-RS.

11. The SCell activation method according to claim 10, further comprising:
sending, by the network side device, a TCI activation command to the terminal, wherein the TCI activation command is used to indicate the terminal to activate the TCI state of the PDCCH or the PDSCH.

12. The SCell activation method according to claim 10, wherein when the CSI-RS is a semi-static CSI-RS, the TCI state of the PDCCH or the PDSCH is consistent with a TCI state of the semi-static CSI-RS; or when the CSI-RS is a periodic CSI-RS, the TCI state of the PDCCH or the PDSCH is consistent with a TCI state of the periodic CSI-RS.

13. A terminal, comprising a processor and a memory storing instructions, wherein the instructions, when executed by the processor, cause the processor to perform operations comprising:
receiving a secondary cell (SCell) activation command, and executing a SCell activation operation based on the SCell activation command, wherein the terminal meets at least one of the following conditions when the processor executes the SCell activation operation:
a first receive beam scanning factor is less than a target receive beam scanning factor;
a first quantity of receive beam scanning times is less than a target quantity of scanning times when L1 reference signal received power (L1-RSRP) measurement is performed; or
there is no condition restriction on a discontinuous reception (DRX) state during L1-RSRP measurement.

14. The terminal according to claim 13, wherein when the terminal meets the following condition: the first receive beam scanning factor is less than the target receive beam scanning factor, the processor executes the SCell activation operation based on the SCell activation command comprises:
performing Automatic Gain Control (AGC) adjustment, wherein duration of the AGC adjustment is positively correlated with the first receive beam scanning factor.

15. The terminal according to claim 14, wherein the duration of the AGC adjustment is a sum of first duration and a product between second duration and a first value, wherein
the first duration is duration between completion of hybrid automatic repeat request HARQ feedback based on the SCell activation command and reception of a first complete synchronization signal block (SSB);
with in-band carrier aggregation, the second duration is a maximum synchronization signal block measurement timing configuration (SMTC) cycle of an activated serving cell and an activated SCell indicated by the SCell activation command; or with inter-band carrier aggregation, the second duration is a maximum SMTC cycle of an activated SCell indicated by the SCell activation command; and
the first value is any one of the following:
a value obtained by subtracting a second value from a product between the first measurement sampling quantity and the first receive beam scanning factor;
a value obtained by subtracting the second value from a product between the first measurement sampling quantity and the target receive beam scanning factor; or
a value obtained by subtracting the second value from a product between the target measurement sampling quantity and the first receive beam scanning factor.

16. The terminal according to claim 13, wherein when the terminal meets the following condition: the first receive beam scanning factor is less than the target receive beam scanning factor, the processor executes the SCell activation operation based on the SCell activation command comprises:
obtaining coarse timing information through cell detection, wherein duration of the cell detection is positively correlated with a first measurement sampling quantity or the first receive beam scanning factor.

17. The terminal according to claim 16, wherein the duration of the cell detection is a product between third duration and a third value, wherein the third duration is an SMTC cycle of an activated SCell indicated by the SCell activation command; and
the third value is any one of the following:
a product between the first measurement sampling quantity and the first receive beam scanning factor;
a product between the first measurement sampling quantity and the target receive beam scanning factor; or
a product between the target measurement sampling quantity and the first receive beam scanning factor.

18. The terminal according to claim 13, wherein when the terminal meets the following condition: the first receive beam scanning factor is less than the target receive beam scanning factor, the processor executes the SCell activation operation based on the SCell activation command comprises:
performing L1-RSRP measurement, wherein duration of the L1-RSRP measurement is positively correlated with a first measurement sampling quantity or the first receive beam scanning factor.

19. The terminal according to claim 13, wherein when the terminal meets the following condition: the first quantity of receive beam scanning times is less than the target quantity of scanning times when L1-RSRP measurement is performed, the processor executes the SCell activation operation based on the SCell activation command comprises:
performing L1-RSRP measurement, wherein the first quantity of scanning times is less than the target quantity of scanning times, and a sum of the first quantity of scanning times and a second quantity of scanning times is greater than or equal to the target quantity of scanning times, wherein the first quantity of scanning times is a quantity of receive beam scanning times in a process of the L1-RSRP measurement, and the second quantity of scanning times is a quantity of receive beam scanning times in a process of cell detection.

20. The terminal according to claim 13, wherein the terminal meets the following condition: there is no condition restriction on the discontinuous reception DRX state during L1-RSRP measurement, the processor executes the SCell activation operation based on the SCell activation command comprises:
when the DRX state is an on state or an off state, performing, by the terminal, the L1-RSRP measurement when receiving an reference signal (RS).
